(19) United States
(12) Patent Application Publication
(10) Pub. No.: US 2018/0145324 A1
(43) Pub. Date: May 24, 2018

(54) LITHIUM ION BATTERY AND POSITIVE ELECTRODE MATERIAL THEREOF

(71) Applicant: Contemporary Amperex Technology Co., Limited, Ningde (CN)

(72) Inventors: Hui Liu, Ningde (CN); Yini Yuan, Ningde (CN); Long Wang, Ningde (CN); Na Liu, Ningde (CN)

(21) Appl. No.: 15/817,304

(22) Filed: Nov. 20, 2017

(30) Foreign Application Priority Data
Nov. 18, 2016 (CN) 201611023977.0

(51) Int. Cl. H01M 4/525; H01M 10/0525; H01M 4/131; H01M 4/136; H01M 4/36; H01M 4/505; H01M 4/58; C01G 53/00

(52) U.S. Cl. CPC H01M 4/525; H01M 10/0525; H01M 4/131; H01M 4/136; H01M 4/366; C01P 2002/50; H01M 4/5825; C01G 53/50; C01G 53/42; C01P 2006/40; H01M 4/505

(57) ABSTRACT

The present invention provides a lithium ion battery and positive electrode material thereof. The positive electrode material includes a high nickel material having a chemical formula of LiNiₓM₁₋ₓO₂ and a coating layer, wherein 0.5≤X<1, M is selected from at least one of Co, Mn, Al, Mg, Ti and Zr, a specific surface area of the positive electrode material is 0.2 to 0.6 m²/g, and a residual lithium content on a surface of the positive electrode material is 200 to 1000 ppm. Compared with the prior art, the positive electrode material for lithium ion battery of the present invention is prepared by solid phase reaction, which not only can significantly reduce the residual lithium content on the surface of the positive electrode material, but also can avoid increase of the specific surface area of the positive electrode material for lithium ion battery.

### CROSS-REFERENCE TO RELATED APPLICATION

The present application claims priority to Chinese patent application No. CN 201611023977.0 filed on Nov. 18, 2016, the whole disclosure of which is incorporated herein by reference.

### BACKGROUND OF THE INVENTION

### Field if the Invention

The present invention generally relates to lithium ion batteries and, more particularly, to a lithium ion battery having desirable cycle stability and a positive electrode material thereof.

### Description of the Related Art

At present, lithium ion batteries have been widely studied and been widely used in mobile phones, portable computers, camcorders, cameras and other mobile electronic devices due to high specific energy, high operating voltage, wide application temperature range, low self-discharge rate, long cycle life, low pollution and desirable safety performance. Lithium ion batteries have gradually replaced traditional batteries in the fields of aviation, aerospace, marine, satellite, small medical equipment and military communication equipment.

Due to relatively high specific capacity, high nickel materials have been widely used as positive electrode materials for lithium ion batteries. However, with the increase of nickel content, residual lithium (such as lithium hydroxide and lithium carbonate) on the surface of the high nickel material increases accordingly. The residual lithium will directly affect gas production of the lithium ion battery during storage, which directly restricts the application of high nickel materials as positive electrode materials for lithium ion batteries.

To reduce the residual lithium content on the surface of high nickel materials, liquid phase precipitation method has been used, in which the lithium ions on surface of the high nickel materials are combined with phosphate ions to form precipitates. The precipitates are calcined to obtain a material coated with lithium phosphate, so as to reduce the residual lithium content on the surface.

To reduce the residual lithium content on the surface of high nickel materials, a layered high nickel positive electrode material can also be fully washed with a specific lithium source aqueous solution, and then the layered high nickel positive electrode material is subjected to solid-liquid separation and drying, to obtain a layered high nickel positive electrode material with controlled residual lithium content on the surface thereof.

However, in the above mentioned methods, the residual lithium on the surface of the high nickel materials are effectively dissolved or converted via liquid phase treatment. The liquid phase treatment will inevitably increase the specific surface area of the high nickel materials. For high nickel positive electrode materials for lithium ion batteries, the larger the specific surface area is, the more the high nickel positive electrode materials contact the electrolyte. Therefore, there will be more side reactions between the positive electrode and the electrolyte, and the capacity of the lithium ion battery during cyclic process will be reduced more rapidly.

In view of the foregoing, what is needed, therefore, is to provide a lithium ion battery having desirable cycle stability and having high nickel material as positive electrode material.

### SUMMARY OF THE INVENTION

One object of the present invention is to provide a lithium ion battery having desirable cycle stability and having high nickel material as the positive electrode material.

According to one embodiment of the present invention, a positive electrode material for lithium ion battery is provided. The positive electrode material includes a high nickel material having a chemical formula of LiNiₓM₁₋ₓO₂ and a coating layer, wherein 0.5≤x<1, M is selected from at least one of Co, Mn, Al, Mg, Ti and Zr, a specific surface area of the positive electrode material is 0.2 to 0.6 m²/g, and a residual lithium content on a surface of the positive electrode material is 200 to 1000 ppm.

According to one aspect of the present invention, the specific surface area of the positive electrode material for lithium ion battery is 0.3 to 0.5 m²/g.

According to one aspect of the present invention, the coating layer including at least one of lithium phosphate, lithium sulfate, lithium nitrate and lithium fluoride.

According to one embodiment of the present invention, a method for preparing a positive electrode material for lithium ion battery includes the steps of:

(1) converting residual lithium on a surface of a high nickel material into stable lithium salts via solid phase reaction and obtaining an intermediate product; and

(2) sintering the intermediate product in step (1) and obtaining the positive electrode material for lithium ion battery.

According to one aspect of the present invention, in step (1), the solid phase reaction includes the step of mixing the high-nickel material with at least one of phosphates, sulfates, nitrates and fluorides and reacting.

According to one aspect of the present invention, an add amount of at least one of phosphates, sulfates, nitrates and fluorides is calculated based on the residual lithium content on the surface of the high nickel material.

According to one aspect of the present invention, the residual lithium content on the surface of the high-nickel material is calculated via chemical titration method.

According to one aspect of the present invention, in step (2), a temperature for sintering the intermediate product is 400 to 800° C., a time for sintering intermediate product is 3 to 12 h, and a heating rate for sintering intermediate product is 1 to 5° C./min. When the sintering temperature is lower than 400° C., the reaction cannot be completely carried out. The temperature cannot be higher than 800° C., otherwise, it will exceed the burning temperature of the material and will reduce the capacity per gram of the material. The sintering time relates to the sintering temperature. When the sintering temperature is high, the time required is reduced, and vice versa. If the heating rate is too slow, the heating efficiency will be affected. If the heating rate is too fast, the thermocouple of the stove will be damaged.

According to one aspect of the present invention, the temperature for sintering the intermediate product is 500 to 600° C., the time for sintering intermediate product is 6 to 8 h, and the heating rate for sintering the intermediate product is 2 to 3° C./min.

According to one aspect of the present invention, the sintering is carried out at an atmosphere of at least one of oxygen, argon and air.

According to one embodiment of the present invention, a lithium ion battery includes a positive electrode, a negative electrode, a separator between the positive electrode and the negative electrode, and electrolyte, wherein the positive electrode includes a positive electrode material including a high nickel material having a chemical formula of LiNiₓM₁₋ₓO₂ and a coating layer, wherein 0.5≤x<1, M is selected from at least one of Co, Mn, Al, Mg, Ti and Zr, a specific surface area of the positive electrode material is 0.2 to 0.6 m²/g, and a residual lithium content on the surface of the positive electrode material is 200 to 1000 ppm.

Compared with the prior art, the lithium ion battery and the positive electrode material thereof according to the present invention have the following advantages:

1) The positive electrode material for lithium ion battery of the present invention is a high nickel material having low residual lithium content on its surface and desirable cycle performance. There is no significant increase in the specific surface area.

2) The method for preparing the positive electrode material for lithium ion battery of the present invention includes a step of removing the residual lithium on the surface of the high nickel material via solid phase reaction method, which can avoid increase of the specific surface area of the material due to the liquid reaction.

3) The lithium ion battery of the present invention adopts the high nickel material having low residual lithium content on the surface thereof and a small specific surface area as the positive electrode material. The lithium ion battery has a slower capacity fading rate during the cycle process.

### BRIEF DESCRIPTION OF THE DRAWINGS

Other advantages and novel features will be drawn from the following detailed description of preferred embodiments with the attached drawings, in which:

FIG. 1 depicts an SEM image (×30000) of a positive electrode material for lithium ion battery according to Comparative Example 1;

FIG. 2 depicts an SEM image (×30000) of a positive electrode material for lithium ion battery according to Example 1 of the present invention;

FIG. 3 depicts an SEM image (×30000) of a positive electrode material for lithium ion battery according to Comparative Example 4;

FIG. 4 depicts an energy dispersive X-ray spectrum of phosphorus element distribution on a surface of the positive electrode material for lithium ion battery according to Example 1 of the present invention;

FIG. 5 depicts a comparison chart of cycle stability curves of positive electrode materials for lithium ion battery of Examples 8 to 9 of the present invention and Comparative Examples 7 to 8; and

FIG. 6 depicts a comparison chart of gas production performance during storage of positive electrode materials for lithium ion battery of Examples 8 to 9 of the present invention and Comparative Examples 7 to 8.

### DETAILED DESCRIPTION OF PREFERRED EMBODIMENTS

Example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements.

### EXAMPLE 1

The high nickel material of Example 1 has a chemical formula of LiNi_{0.6}Co_{0.2}Mn_{0.2}O₂. The method for preparing the positive electrode material for lithium ion battery of Example 1 includes the steps of:

determining the residual lithium (LiOH, Li₂CO₃) content on the surface of the high nickel material by chemical titration method, and calculating the theoretical amount of NH₄H₂PO₄ required for complete precipitation of lithium residues;

fully mixing the high nickel material with NH₄H₂PO₄ and obtaining an intermediate product, wherein a molar ratio of NH₄H₂PO₄ added to the residual lithium (Li⁺) content on the surface of the high nickel material is 1: 3; and

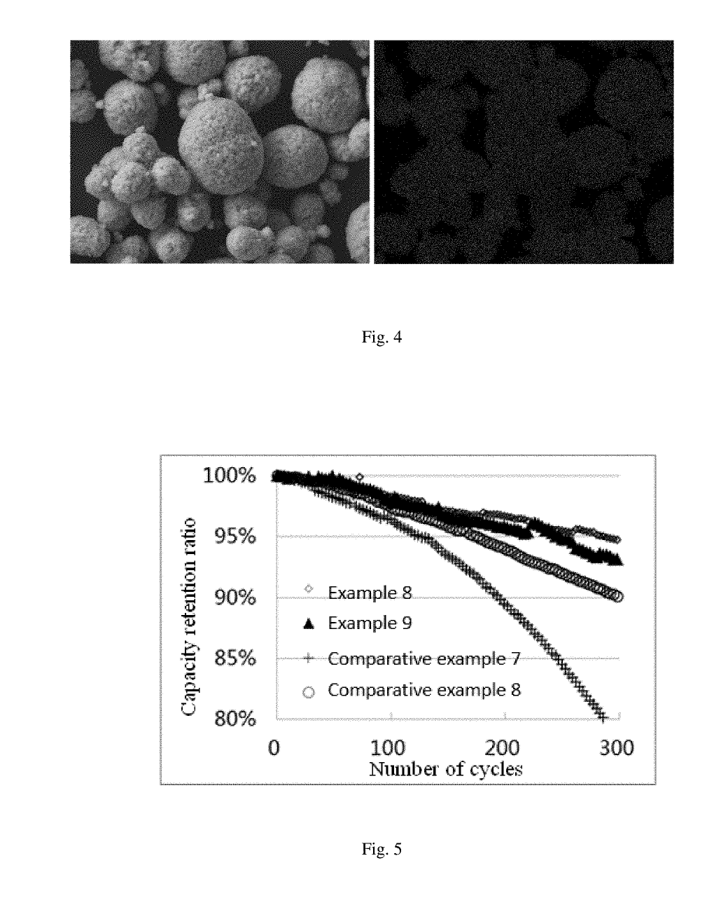

sintering the intermediate product at 500° C. for 6 h at a heating rate of 2° C./min, and obtaining the positive electrode material for lithium ion battery having a coating layer of lithium phosphate. The SEM image of the positive electrode material for lithium ion battery of Example 1 is shown in FIG. 2, and the EDS diagram of phosphorus element distribution on the surface is shown in FIG. 4.

### EXAMPLE 2

The high nickel material of Example 2 has a chemical formula of LiNi_{0.6}Co_{0.2}Mn_{0.2}O₂. The method for preparing the positive electrode material for lithium ion battery of Example 2 differs from Example 1 in that, in Example 2, the heating rate is 5° C./min and the intermediate product is sintered at 600° C. for 4 h. The positive electrode material for lithium ion battery obtained has a coating layer of lithium phosphate.

### EXAMPLE 3

The high nickel material of Example 3 has a chemical formula of LiNi_{0.8}Co_{0.15}Al_{0.05}O₂. The method for preparing the positive electrode material for lithium ion battery of Example 3 differs from Example 1 in that, in Example 3, the heating rate is 5° C./min and the intermediate product is sintered at 700° C. for 4 h. The positive electrode material for lithium ion battery obtained has a coating layer of lithium phosphate.

### EXAMPLE 4

The high nickel material of Example 4 has a chemical formula of LiNi_{0.5}Co_{0.5}O₂. The method for preparing the positive electrode material for lithium ion battery of Example 4 differs from Example 1 in that, in Example 4, the heating rate is 2° C./min and the intermediate product is sintered at 800° C. for 3 h. The positive electrode material for lithium ion battery obtained has a coating layer of lithium phosphate.

### EXAMPLE 5

The high nickel material of Example 5 has a chemical formula of LiNi_{0.6}Co_{0.2}Mn_{0.15}Ti_{0.05}O₂. The method for preparing the positive electrode material for lithium ion battery of Example 5 includes the steps of:

determining the residual lithium (LiOH, Li₂CO₃) content on the surface of the high nickel material by chemical titration method, and calculating the theoretical amount of (NH₄)₂SO₄ required for complete precipitation of lithium residues; fully mixing the high nickel material with (NH₄)₂SO₄ and obtaining an intermediate product, wherein a molar ratio of (NH₄)₂SO₄ added to the residual lithium (Li⁺) content on the surface is 1: 2; and

sintering the intermediate product at 500° C. for 6 h at a heating rate of 2° C./min and obtaining the positive electrode material for lithium ion battery having a coating layer of lithium sulfate.

### EXAMPLE 6

The high nickel material of Example 6 has a chemical formula of LiNi_{0.6}Co_{0.2}Mn_{0.15}Zr_{0.05}O₂. The method for preparing the positive electrode material for lithium ion battery of Example 6 includes the steps of:

determining the residual lithium (LiOH, Li₂CO₃) content on the surface of the high nickel material by chemical titration method, and calculating the theoretical amount of NH₄NO₃ required for complete precipitation of lithium residues;

fully mixing the high nickel material with NH₄NO₃ and obtaining an intermediate product, wherein a molar ratio of NH₄NO₃ added to the residual lithium (Li⁺) content on the surface is 1:1; and

sintering the intermediate product at 500° C. for 6 h at a heating rate of 2° C./min and obtaining a positive electrode material for lithium ion battery having a coating layer of lithium nitrate.

### EXAMPLE 7

The high nickel material of Example 7 has a chemical formula of LiNi_{0.5}Co_{0.25}Mn_{0.25}O₂. The method for preparing the positive electrode material for lithium ion battery of Example 7 includes the steps of:

determining the residual lithium (LiOH, Li₂CO₃) content on the surface of the high nickel material by chemical titration method, and calculating the theoretical amount of NH₄F and NH₄NO₃ required for complete precipitation of lithium residues;

fully mixing the high nickel material with NH₄F and NH₄NO₃ and obtaining an intermediate product, wherein a molar ratio of NH₄F and NH₄NO₃ added to the residual lithium (Li⁺) content on the surface is 1:1; and

sintering the intermediate product at 400° C. for 8 h at a heating rate of 2° C./min and obtaining the positive electrode material for lithium ion battery having a coating layer including lithium fluoride and lithium nitrate.

### EXAMPLE 8

The positive electrode material for lithium ion battery of Example 1, the conductive agent acetylene black and the binder polyvinylidene fluoride (PVDF) are added into N-methylpyrrolidone solvent system at a weight ratio of 94:3:3 to obtain a mixture, the mixture is fully stirred to obtain a slurry, the slurry is coated on an aluminum foil, dried and cold pressed to obtain a positive electrode.

The active materials artificial graphite and hard carbon, the conductive agent acetylene black, the binder styrene-butadiene rubber (SBR) and the thickening agent carbon methyl cellulose sodium (CMC) are added into deionized water solvent system at a weight ratio of 90:5:2:2:1 to obtain a mixture, the mixture is fully stirred to obtain a slurry, and the slurry is coated on a copper foil, dried and cold pressed to obtain a negative electrode.

PE porous polymer film is used as the separator.

The positive electrode, the separator and the negative electrode are stacked in order with the separator set between the positive electrode and the negative electrode to obtain an electrode group. The electrode group is wound to obtain a bare cell. The bare cell is placed in a package. The electrolyte is injected into the package. A lithium ion battery is finally obtained after encapsulating the battery package.

### EXAMPLE 9

Example 9 differs from Example 8 in that, in Example 9, the positive electrode material is the positive electrode material for lithium ion battery obtained in Example 2.

### COMPARATIVE EXAMPLE 1

The positive electrode material of Comparative Example 1 is an untreated positive electrode material having a chemical formula of LiNi_{0.6}Co_{0.2}Mn_{0.2}O₂, and the SEM image of Comparative Example 1 is shown in FIG. 1.

### COMPARATIVE EXAMPLE 2

The positive electrode material of Comparative Example 2 is an untreated positive electrode material having a chemical formula of LiNi_{0.8}Co_{0.15}Al_{0.05}O₂.

### COMPARATIVE EXAMPLE 3

The positive electrode material of Comparative Example 3 is an untreated positive electrode material having a chemical formula of LiNi_{0.5}Co_{0.5}O₂.

### COMPARATIVE EXAMPLE 4

Comparison Experiment of Removing Residual Lithium from High Nickel Material by Liquid Phase Method

The high nickel material has a structural formula of LiNi_{0.6}Co_{0.2}Mn_{0.2}O₂. The residual lithium (LiOH, Li₂CO₃) content on the surface of the high nickel material is determined by chemical titration method. The theoretical amount of phosphate ion required for complete precipitation of lithium residues is calculated. The calculated value is converted to the dosage of NH₄H₂PO₄. Corresponding NH₄H₂PO₄ is dispersed in water to obtain a NH₄H₂PO₄ solution.

The high nickel material is soaked in NH₄H₂PO₄ solution and stirred for 3 hours to disperse evenly to obtain an intermediate product. The intermediate product is then dried.

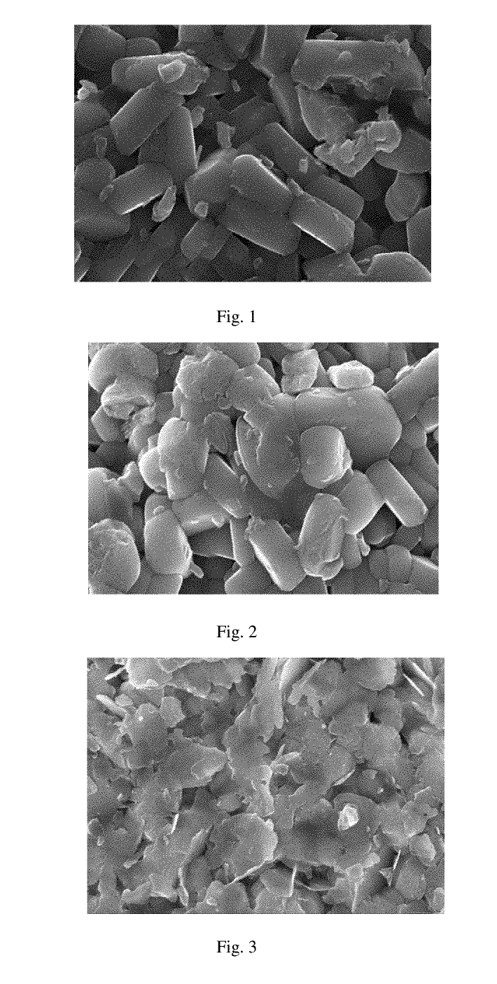

The obtained dried intermediate product is sintered at 500° C. in an air atmosphere for 6 h at a heating rate of 3° C./min to obtain a high nickel material with the residual lithium removed by liquid phase method, the SEM image of which is shown in FIG. 3.

### COMPARATIVE EXAMPLE 5

Comparison Experiment of Removing Residual Lithium from the High Nickel Material by Liquid Phase Method

The high nickel material has a structural formula of LiNi_{0.5}Co_{0.5}O₂. The residual lithium (LiOH, Li₂CO₃) content on the surface of the high nickel material is determined by chemical titration method. The theoretical amount of phosphate ion required for complete precipitation of lithium residues is calculated. The calculated value is converted to the dosage of NH₄H₂PO₄. Corresponding NH₄H₂PO₄ is dispersed in ethanol to obtain a NH₄H₂PO₄ solution.

The high nickel material is soaked in NH₄H₂PO₄ solution and stirred for 3 hours to disperse evenly to obtain an intermediate product. The intermediate product is then dried.

The obtained dried intermediate product is sintered at 500° C. in an air atmosphere for 6 h at a heating rate of 3° C./min to obtain a high nickel material with the residual lithium removed by liquid phase method.

### COMPARATIVE EXAMPLE 6

Comparison Experiment of Removing Residual Lithium from High Nickel Material by Liquid Phase Method

The high nickel material has a structural formula of LiNi_{0.8}Co_{0.15}Al_{0.05}O₂. The residual lithium (LiOH, Li₂CO₃) content on the surface of the high nickel material is determined by chemical titration method. The theoretical amount of phosphate ion required for complete precipitation of lithium residues is calculated. The calculated value is converted to the dosage of NH₄H₂PO₄. Corresponding NH₄H₂PO₄ is dispersed in water to obtain a NH₄H₂PO₄ solution.

The high nickel material is soaked in NH₄H₂PO₄ solution and stirred for 3 hours to disperse evenly to obtain an intermediate product. The intermediate product is then dried.

The obtained dried intermediate product is sintered at 500° C. in an air atmosphere for 6 h at a heating rate of 3° C./min to obtain a high nickel material with the residual lithium removed by liquid phase method.

### COMPARATIVE EXAMPLE 7

The high nickel material of Comparative Example 1, the conductive agent acetylene black and the binder polyvinylidene fluoride (PVDF) are added into N-methylpyrrolidone solvent system at a weight ratio of 94:3:3 to obtain a mixture, the mixture is fully stirred to obtain a slurry, and the slurry is coated on an aluminum foil, dried and cold pressed to obtain a positive electrode.

The active materials artificial graphite and hard carbon, the conductive agent acetylene black, the binder styrene-butadiene rubber (SBR) and the thickening agent carbon methyl cellulose sodium (CMC) are added in to deionized water solvent system at a weight ratio of 90:5:2:2:1 to obtain a mixture, the mixture is fully stirred to obtain a slurry, the slurry is coated on a copper foil, dried and cold pressed to obtain a negative electrode.

PE porous polymer film is used as a separator.

The positive electrode, the separator and the negative electrode are stacked in order with the separator set between the positive electrode and the negative electrode to obtain an electrode group. The electrode group is wound to obtain a bare cell. The bare cell is placed in a package. The electrolyte is injected into the package. A lithium ion battery is finally obtained after encapsulating the battery package.

### COMPARATIVE EXAMPLE 8

Comparative Example 8 differs from Comparative Example 7 only in that the high nickel material of Comparative Example 1 is the high nickel material obtained in Comparative Example 4 via removing the residual lithium by liquid phase method.

### COMPARATIVE EXAMPLE 9

Comparative Example 9 differs from Comparative Example 7 only in that the high nickel material of Comparative Example 9 is the high nickel material obtained in Comparative Example 5 via removing the residual lithium by liquid phase method.

### Comparative Experiment 1

### Comparison of Residual Lithium (Li⁺) Content and Specific Surface Area (BET)

The positive electrode materials for lithium ion battery prepared in Examples 1 to 7 and Comparative Examples 1 to 6 are subjected to comparative experiment of residual lithium (Li⁺) content and specific surface area (BET) under same condition.

Method of comparative experiment of residual lithium (Li⁺) content uses acid-base titration method, in which hydrochloric acid standard solution is used to titrate lithium carbonate and lithium hydroxide in the high-nickel material, pH electrode is used as the indicator electrode, the end point is determined by a sudden change of the potential change, and the residual lithium content on the surface of the positive electrode material is calculated. The experimental results are shown in Table 1.

TABLE 1
Residual lithium content and specific surface area of the high nickel material of
Examples 1 to 7 and Comparative Examples 1 to 6

| Items | Unit | E 1 | E 2 | E 3 | E 4 | E 5 | E 6 | E 7 | CE 1 | CE 2 | CE 3 | CE 4 | CE 5 | CE 6 |
|---|---|---|---|---|---|---|---|---|---|---|---|---|---|---|
| Li⁺ | ppm | 720 | 750 | 857 | 360 | 734 | 746 | 350 | 1362 | 1532 | 735 | 754 | 372 | 865 |
| BET | m²/g | 0.28 | 0.30 | 0.37 | 0.35 | 0.36 | 0.35 | 0.32 | 0.27 | 0.35 | 0.32 | 0.58 | 0.71 | 0.72 |

Example 1 is simplified as E 1, Comparative Example 1 is simplified as CE 1, and so on.

It can be seen from Table 1, compared with the original high nickel material in Comparative Examples 1 to 3, the residual lithium content on the surface of the positive electrode material prepared by the method of the present invention is reduced remarkably, which indicates that the residual lithium on the surface of the positive electrode material is converted into other lithium salts effectively. According to FIG. 4, the residual lithium (Li₂CO₃ and LiOH) is converted to Li₃PO₄. In addition, compared with the original high nickel material in Comparative Examples 1 to 3, the BET of the positive electrode material prepared by the method of the present invention does not increase significantly, while the BET of the material prepared by the liquid phase method is doubled.

### Comparative Experiment 2

### Comparison of Cycle Stability

The positive electrode materials for lithium-ion battery prepared in Examples 8 to 9 and Comparative Examples 7 to 8 are subjected to the experiment of cycle stability under same condition.

In the experiment, the battery is charged to 4.2V at 1 C (C for the battery capacity) constant current and is discharged at 1 C constant current at 25° C.

The experimental results are shown in FIG. 5. It can be seen that, the cycle stability of the battery having the positive electrode material prepared by the method of the present invention is improved remarkably, which indicates that the coating layer on the surface of the positive electrode material for lithium ion battery can improve the cycle stability effectively. At the same time, via comparison of the data of Examples 8 to 9 and Comparative Examples 7 to 8, it can be found that the battery having the positive electrode material with the residual lithium removed by liquid phase method has poor cycle stability. Also referring to the specific surface area data in Table 1, it is shown that the contact area between the material modified by liquid phase method and the electrolyte is larger, the side reaction is more and the cycle stability is worse.

### Comparative Experiment 3

Comparison of Gas Production Performance during Storage

The positive electrode materials for lithium-ion battery prepared in Examples 8 to 9 and Comparative Examples 7 to 8 are subjected to the comparative experiment of gas production performance during storage under same condition.

The experimental method includes the steps of: fully charging the batteries, placing the batteries in an incubator at 60° C., and testing the volume of each battery every 15 days.

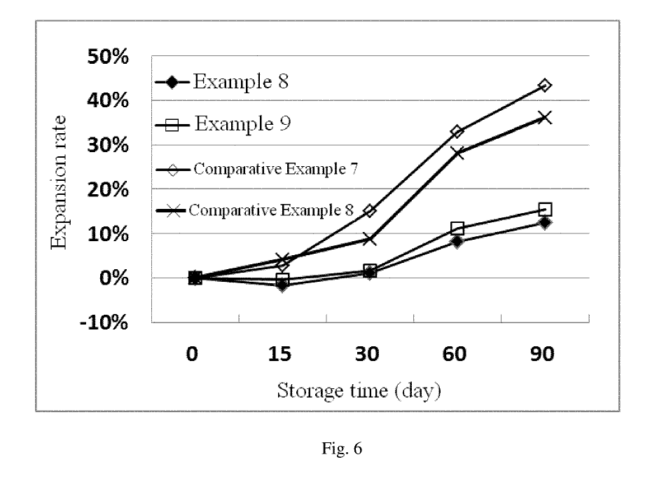

The experimental results are shown in FIG. 6. It can be seen from FIG. 6 that gas generated during storage of the battery having the positive electrode material prepared by the method of the present invention is less. The liquid-phase method can hardly reduce the gas generated during storage, mainly due to the damage to the surface of the material due to liquid phase treatment, exposure of more active sites, larger specific surface area of the material, which results in more side effects under high temperature conditions. Thus, the amount of gas produced of the Comparative Example is relatively larger relative to the method of the present invention.

Compared with the prior art, the lithium ion battery and the positive electrode material thereof according to the present invention have the following advantages:

1) The positive electrode material for lithium ion battery of the present invention is a high nickel material having low residual lithium content on a surface thereof and desirable cycle performance. There is no significant increase in specific surface area.

2) The method for preparing the positive electrode material for lithium ion battery of the present invention includes the step of removing the residual lithium on the surface of the high nickel material via solid phase reaction method, which can avoid increase of the specific surface area of the material due to the liquid phase reaction.

3) The lithium ion battery of the present invention adopts the high nickel material having low residual lithium content on the surface thereof and a small specific surface area as the positive electrode material. The lithium ion battery has a slower capacity fading rate during the cycle process.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions describe example embodiments, it should be appreciated that alternative embodiments without departing from the scope of the appended claims. Although specific terms are employed herein, they are used in a generic and descriptive sense only and not for purposes of limitation.

What is claimed is:

1. A positive electrode material for lithium ion battery comprising a high nickel material having a chemical formula of LiNiₓM₁₋ₓO₂ and a coating layer, wherein 0.5≤x<1, M is selected from at least one of Co, Mn, Al, Mg, Ti and Zr, a specific surface area of the positive electrode material is 0.2 to 0.6 m²/g, and a residual lithium content on a surface of the positive electrode material is 200 to 1000 ppm.

2. The positive electrode material of claim 1, wherein the specific surface area of the positive electrode material is 0.3 to 0.5 m²/g.

3. The positive electrode material of claim 1, wherein the coating layer comprising at least one of lithium phosphate, lithium sulfate, lithium nitrate and lithium fluoride.

4. A method for preparing the positive electrode material of claim 1, comprising the steps of:
(1) converting residual lithium on a surface of a high nickel material into stable lithium salts via solid phase reaction and obtaining an intermediate product; and
(2) sintering the intermediate product obtained in step (1) and obtaining the positive electrode material for lithium ion battery.

5. The method of claim 4, wherein in step (1), the solid phase reaction comprises the step of mixing the high nickel material with at least one of phosphates, sulfates, nitrates and fluorides and reacting.

6. The method of claim 5, wherein an add amount of at least one of phosphates, sulfates, nitrates and fluorides is calculated based on the residual lithium content on the surface of the high nickel material.

7. The method of claim 6, wherein the residual lithium content on the surface of the high nickel material is calculated via chemical titration method.

8. The method of claim 4, wherein in step (2), a temperature for sintering the intermediate product is 400 to 800° C., a time for sintering the intermediate product is 3 to 12 h, and a heating rate for sintering the intermediate product is 1 to 5° C./min.

9. The method of claim 8, wherein the temperature for sintering the intermediate product is 500 to 600° C., the time for sintering the intermediate product is 6 to 8 h, and the heating rate for sintering the intermediate product is 2 to 3° C./min.

10. A lithium ion battery, comprising a positive electrode, a negative electrode, a separator between the positive electrode and negative electrode, and electrolyte, wherein the positive electrode comprises the positive electrode material for lithium ion battery of claim 1.
